(19) United States
(12) Patent Application Publication
(10) Pub. No.: US 2006/0080616 A1
(43) Pub. Date: Apr. 13, 2006

(54) Systems, methods and user interfaces for document workflow construction

(75) Inventors: Vincent P. Vogel, Hawthorn, CA (US); Princess R. Bravo, Torrance, CA (US); William Jang, Redondo Beach, CA (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/962,844

(22) Filed: Oct. 13, 2004

(51) Int. Cl. G06F 3/00

(52) U.S. Cl. 715/769

(57) ABSTRACT

Context sensitive drag-and-drop systems, methods and user interfaces are provided in a Graphical User Interface (GUI) computing environment. Icons representing various tasks may be interactively drag-and-dropped to an adjoining graphically-based workspace in a context-based task-drop location to simply and intuitively construct a graphically-based workflow solution. A collapsible error handling failure branch may be constructed concurrently with the main branch of the workflow process. A loopback path to a higher branch may optionally be constructed for the failure branch. The workflow solution may be applied in a document printing environment for document production, a document copying environment, or an accounting environment, for example, for clear and efficient generation of workflows.

This application includes a computer program listing appendix submitted on a compact disc (Copies 1 and 2) containing a computer code that performs the disclosed user interface features for document workflow construction. The computer code in the compact disc is in an MS-DOS file called WFPane.doc of size 312 KB created on Aug. 18, 2004. The entirety of the computer program listing appendix submitted on the compact disc is hereby incorporated by reference.

### BACKGROUND OF THE INVENTION

1. Field of Invention

This invention relates to a Graphical User Interface (GUI), and is directed to systems, methods and user interfaces for document workflow construction.

2. Description of Related Art

Document workflow construction is used for constructing a print workflow to orchestrate and construct the flow of a prepress activity. Conventionally, an order is initiated to process an electronic document file for print production. The electronic document file may then be converted into a PDF format, verified, managed, with certain templates imposed, proofed and printed. Conventionally, the print production process may be manual, partially automated, or operated in a digitized computing environment.

In a computing environment, certain conventional techniques are known for document workflow construction. Typically, they are graphically-based techniques, such as CaslonSoft's CaslonFlow. However, CaslonFlow offers an overly flexible graphical solution. The user interactively drops the workflow tasks anywhere in the graphical workspace. The user then interactively links the task with another of his choosing.

CaslonFlow's graphical construction of workflow allows free positioning and association of workflow tasks in the graphical workspace. Such an unconstrained graphical solution quickly leads to constructing a confusing tangle of linked tasks that graphically overlay or cross each other. Other techniques, such as Creo's Prinergy, offer an overly constrained graphical solution. Furthermore, Creo's Prinergy does not provide for failure branching in case of error conditions in the task flow.

### SUMMARY OF THE INVENTION

Conventional workflow solutions are either too flexible or too constrained, and are ineffective in laying out a clear document workflow construction. Accordingly, a need for a more balanced solution to workflow construction exists.

Systems, methods, and user interfaces are provided that overcome much of the complexity and/or limitations associated with the conventional workflow solutions. A GUI-based solution to efficiently construct workflows using graphically-based icons and links is also provided. Simple and intuitive systems, methods, and user interfaces which overcome much of the noted complexity and/or limitations associated with the conventional graphically-based solutions are also provided. Systems, methods, and user interfaces that allow a construction of workflow representation based on context-sensitive drag-and-drop of icons, such as an icon representing a task, in a graphical workflow pane are also provided. The workflow construction may be created, modified, and/or administered upon creation.

In one aspect, a link between a pre-positioned icon in a workspace and an icon being dragged and dropped may be automatically established for a simple and intuitive construction of a row of workflow tasks. One or more error-handling branches may be provided and branched from each row of task. To allow the user to focus on the primary workflow, the at least one error-handling branch may be collapsible.

In another aspect, task drop locations may indicate to the user where they can add tasks, both for success and failure branches. Preferably, a failure branch appears branched from a particular row of task, for example, branched below and offset to the right of a particular task. Failure branches may be collapsed so that preferably at most one failure branch is open at a time. Such features, along with other important characteristics, allow workflows to be efficiently constructed.

In various exemplary implementations, when a toolbar task is dragged over a blank area of the workflow pane, a drop location may appear at the end of the main branch of tasks. Tasks may be re-ordered by dragging and dropping tasks in the workflow pane. In general, various rules may be used to govern whether certain tasks can be dropped into the various drop locations.

In various exemplary implementations, tasks in the workflow pane may preferably be placed one after the other to the right, for example, signifying successful processing. Tasks in the workflow pane preferably may appear in a preset, left to right progression.

In various exemplary implementations, each task in the workflow pane may have a failure branch appearing down and to the right. If task processing succeeds, workflow execution will flow to the task to the right. If task processing fails, workflow execution will flow to the failure branch.

In various exemplary implementations, for each row of tasks, only one task may preferably have a failure branch open at a time. Such an approach helps to prevent the failure branches from overlapping each other and to keep the row of primary tasks together for a consistent visual appearance.

In various exemplary implementations, a loop back may be added to a fail branch to loop up to a higher branch or a designated task.

The various exemplary systems, methods and user interfaces for document workflow construction described herein may be applicable to various applications requiring workflow construction, including, for example, print or copy production; accounting; and publication, news or advertising prepress workflows.

These and other features and advantages of this invention are described in, or apparent from, the following detailed descriptions of various exemplary implementations.

### BRIEF DESCRIPTION OF THE DRAWINGS

Various details of the invention are described herein with reference to the following figures, wherein:

FIG. 1 illustrates a screen view of an exemplary workflow builder primary window combining the views of a main menu and a workspace area;

FIG. 2 illustrates a screen view of an exemplary loop back setting dialog;

FIG. 3 is a schematic illustration of an exemplary workflow;

FIG. 4 illustrates a screen view of an exemplary workflow creation and editing area of the workspace;

FIG. 5 is a schematic illustration of another exemplary workflow; and

FIG. 6 is a schematic illustration of an exemplary reprint workflow.

### DETAILED DESCRIPTION

The following detailed description of various exemplary systems, methods and user interfaces for document workflow construction may refer to and/or illustrate an application in production printing, for sake of clarity and familiarity. However, it should be appreciated that the principles of this invention outlined and/or discussed below can be equally applied to any known or later developed applications amenable to workflow construction.

A workflow builder may be provided with a user interface to create, modify and/or administer automated workflows. The workflow builder may enable a user to interactively drag-and-drop a toolbar task from a toolbar palette to a workflow pane.

Workflows may be enabled or disabled. The workflow builder may be accessed at any phase of prepress or print activities. For example, during a PDF file submission, a user may invoke the workflow builder to create a new workflow. Similarly, the workflow builder may be accessed from a PDF job manager.

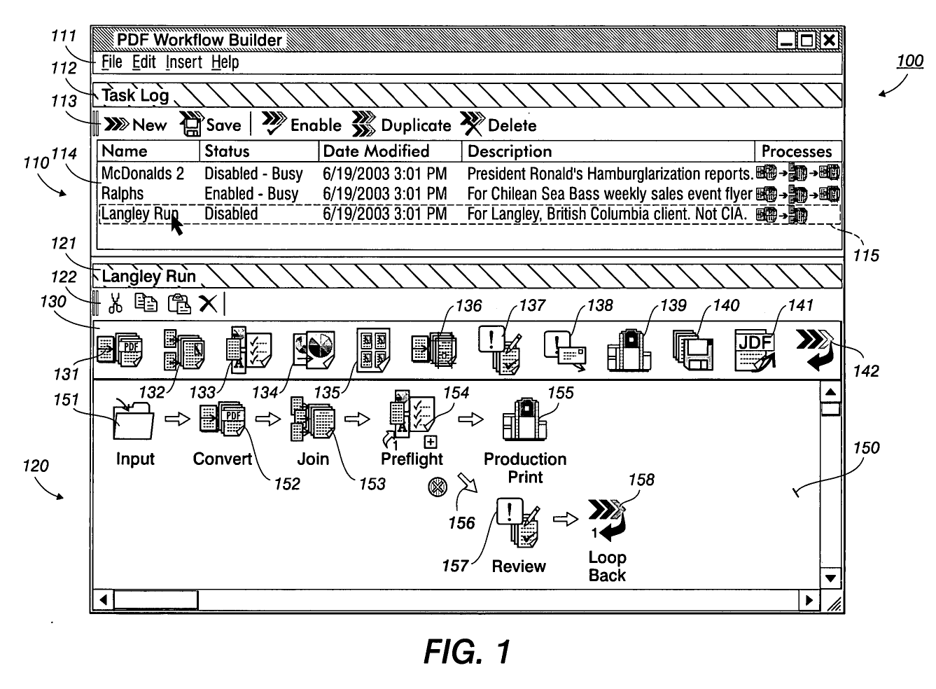

FIG. 1 illustrates an exemplary screen view of a primary window 100 of a workflow builder. The exemplary screen view combines the views of a main menu 110 and a workspace area 120 for illustrative purposes. The workflow builder may facilitate interactive entries through dialogs graphically displayed as windows.

As shown in FIG. 1, the main menu 110 in the dialog may list the workflows configured on the system. For illustrative purposes, an application title bar 101 may identify the workflow builder with an application title, such as “PDF Workflow Builder.” Below the application title bar 101, a main menu bar 111 may be shown listing drop-down menus, such as File, Edit, Insert and Help. Below the main menu bar 111, a title bar 112 may be shown such as “Workflows,” followed by a toolbar 113 listing toolbar buttons, such as New, Save, Enable, Duplicate and Delete. A workflow list table 114 may list the workflows by rows, the workflow information 115 comprising such fields as Name, Status, Date Modified, Description, and Processes, for example, for each workflow listing. The listing may be sorted by a field category.

FIG. 1 shows an exemplary view in which “Langley Run” workflow is selected for demonstrative purposes. When a user selects a workflow in the workflow list 114, the row of selected workflow information 115 in the workflow list 114 may be highlighted, and the corresponding graphical representation of the selected workflow being displayed in the workspace area 120. If the selected workflow does not have jobs being processed, then the selected workflow is enabled and may be available for editing. If an enabled workflow is edited, then the selected workflow may revert to the disabled status upon commencement of editing.

A new workflow may be created by selecting the New toolbar button from the toolbar 113 or a menu item. A new workflow adds a row of workflow to the workflow list table 114. The row of new workflow information 115 may be highlighted to show that it is selected.

Controls for the workspace area may be effected via the main menu bar 111, for example, using the File, Edit, Insert and Help menus; the toolbar/command buttons 113, for example, using New, Save, Enable, Duplicate and Delete; mouse controls, such as point-and-double click, point-and-click, and drag-and-drop; context menus, e.g., New, Save, separator line, Properties, Enable/Disable, Duplicate, Rename and Delete; and keyboard access shortcuts. In lieu of a mouse, keyboard cursor keys may also be used to navigate the workspace.

A context menu may be opened, for example, by pointing a cursor over a workflow listed in the workflow list table and right clicking the mouse. Among the context menu items, choosing the Properties menu opens a workflow properties dialog.

From the workflow builder primary window 100, workflows may be managed. For example, selecting the Enable toolbar button from the toolbar 113 enables a selected workflow to accept jobs submitted to the workflow; selecting the Duplicate toolbar button from the toolbar 113 adds a copy of the selected workflow row to the workflow list and provides a cursor for editing; and selecting the Delete toolbar button from the toolbar 113 invokes a basic confirmation dialog to delete a selected workflow in the workflow list 114.

As shown in the lower portion of FIG. 1, the workspace area 120 may have a title bar 121. For demonstrative purposes, the title “Langley Run” is shown in FIG. 1. For illustrative purposes, below the title bar 121 is a workspace area toolbar 122 with toolbar buttons, such as Cut 123, Copy 124, Paste 125 and Delete 126. Selecting the Cut 123 toolbar button deletes and stores the selected process for pasting; selecting the Copy 124 toolbar button stores the selected process in a cache for pasting; selecting the Paste 125 toolbar button pastes a process copied from a different place; and selecting the Delete 126 toolbar button deletes a process. Paste as Fail Branch may be invoked from the Edit menu of the menu bar 111 to paste a process step copied from a different place as a fail branch of the selected process. These and other features may also be implemented as a respective toolbar button.

For illustrative purposes, below the workspace area toolbar 122 is a workflow creation and editing area comprising a Workflow Process Options area 130 and a workspace 150. The workspace 150 is where workflow process plans are built, displayed, and modified. The workspace 150 of the dialog is used to construct a graphical representation of the selected workflow 115. The workspace 150 includes workflow process steps and the links between the process steps. Users preferably interact with the workspace 150 largely through direct manipulation of graphics objects, also referred to as building block objects. Properties of the building block objects may be configured using secondary pop-up dialogs.

The workflow builder allows a construction of a workflow representation in the workspace 150 based on context-sensitive drag-and-drop of icons selected from the Workflow Process Options area 130. For illustrative purposes, the Workflow Process Options area 130 in FIG. 1 shows exemplary workflow tasks that may be selected as drag-and-drop icons, such as Join 131, Convert 132, Review 133, Color Management 134, Impose 135, Job Level Edit 136, Notify 137, Preflight 138, Print Production 139, Save Job 140, JDF Export 141, and Loop Back 142. The workflow construction may be created, modified, and/or administered upon creation.

In the workspace 150, a link between a pre-positioned icon and an icon being dragged and dropped may be established automatically for a simple and intuitive construction of a row of workflow tasks. Workflow tasks in the workspace 150 may be placed one after the other to the right, signifying successive processing. Tasks in the workspace 150 may appear in a preset, left to right progression, for example starting with the Input 151 (or Start) icon. Workflow tasks may be re-ordered by dragging and dropping icons in the workspace 150. In general, various rules may be used to govern whether certain tasks can be dropped into the various drop locations, as further discussed below.

Distinctly sized icons may indicate to the user task drop locations in the workspace 150 where they can add tasks, both for success and failure branches. When a workflow task from the Workflow Process Options area 130 is dragged over a blank area of the workspace 150, a drop location may appear at the end of the main branch of tasks.

Each task in the workspace 150 may have a failure branch 156 appearing down and to the right. If task processing succeeds, workflow execution flows to the task to the right. If task processing fails, workflow execution flows to the failure branch. One task may, for example, have only one failure branch open at a time. This measure may help to prevent failure branches from overlapping each other and help to keep the row of primary tasks together for a consistent visual appearance. Optionally, a Loop Back 158 may be added to a fail branch 156 to loop up to a higher branch or a designated task. For demonstrative purposes, the Preflight 154 in the workspace 150 of FIG. 1 is shown associated with a Loop Back Target icon (Table 1) to represent a loop back path destination.

In the workspace 150, one or more error-handling branches 156 may be provided and branched from each row of tasks. To allow the user to focus on the primary workflow, the at least one error-handling branch may be collapsible. For illustrative purposes, FIG. 1 shows Preflight 154 in the workspace 150 with a “+” sign to indicate the status that the error-handling branch is collapsed. (However, FIG. 1 actually shows the error-handling branch 156 opened for illustrative purposes). Clicking the “+” sign will typically open the error-handling branch 156 in the workspace 150, as shown in FIG. 1. A failure branch (156-158) may appear branched from a particular row of tasks (151-155), for example, branched below and offset to the right of a particular task 154. These features, along with other featured characteristics, may be implemented to allow workflows to be efficiently constructed.

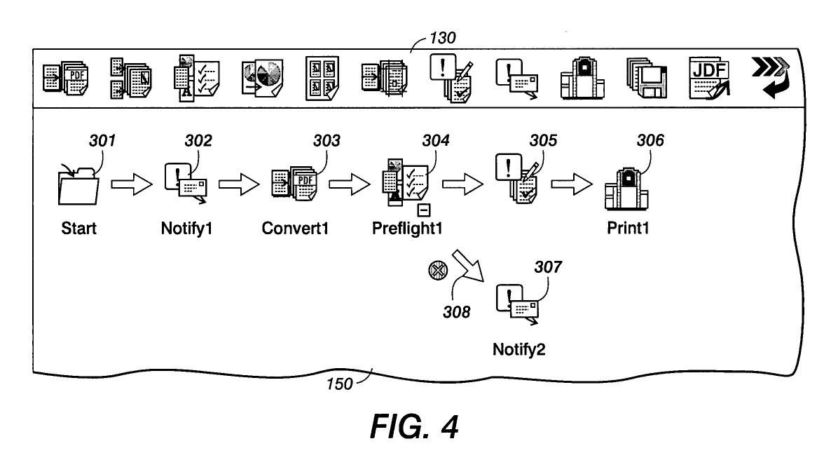

The workspace 150 is designed for simple and intuitive workflow construction. Process steps shown as graphic objects may be arranged in sequence from left to right. Upon placement of a process step, a link may be automatically drawn to an existing process step. Drop locations may be used to aid users by indicating where they can place selected objects in the workspace 150. Pass and Fail conditional links may also be displayed graphically. (See, FIGS. 3-6, for example.) Contingency workflow steps for “fail” conditions may be added by branching the workflow via an angled fail process arrow 156, for example, branching below the failed process 154. (See, FIGS. 1 and 4, for example). Branching of process steps may also be implemented. (See, Vertical Arrow of Table 1, for example.)

Each graphic object representing a process step in the workspace 150 may have a unique name. Multiple occurrences of a given process step in the workspace 150 may be resolved by assigning a uniquely identifying name to each process step. For example, sequential numbering may be added to the process names if there is more than one instance of a particular process type, for example, Preflight1, Preflight2, Preflight3, and so on.

Table 1 provides a non-exhaustive list of exemplary graphic objects, including the workflow task icons, that may be created/manipulated in the workspace 150. If a movable process object is listed, the “Process Object” entry is indicated by “Yes” in the table. The listing is not intended to be a complete listing, but is intended to exemplify graphic objects that may be employed.

TABLE 1

| | Process | |
|---|---|---|
| Name of Icon | Object? | Description of the Graphic Object |
| Input | No | Present in the workspace to mark the |
| (also Start) | | start of a workflow. |
| Join | Yes | Join files into one document. |
| Convert | Yes | Convert files to PDF files. |
| Review | Yes | Notify user/operator to request |
| (Approve/Edit) | | approval or manual editing |
| | | before proceeding. |
| Color Management | Yes | Edit the color set up of the PDF job. |
| Impose | Yes | Setup the print layout. |
| Job Level Edit | Yes | Automatically edit the job for |
| | | margins, page numbering, |
| | | watermarks, etc. |
| Notify | Yes | Notify the operator/user. Preferably, |
| | | an e-mail is sent to the recipient |
| | | to notify job status or to |
| | | request action. |
| Preflight | Yes | Check the PDF job for completeness. |
| Production Print | Yes | Print a PDF file. |
| Save Job | Yes | Save the PDF job. |
| JDF Export | Yes | Export selected JDF file. |
| Loop Back | Yes | Define an optional feature where a |
| (optional) | | failed process is returned in the |
| | | workflow. The associated link |
| | | and/or the number of the originating |
| | | Loop Back Target are optionally |
| | | identified. |
| Horizontal Arrow | No | Directional arrow between sequenced |
| (Pass Conditional | | processes placed in a flow. A |
| Link) | | distinctly bold arrow may be used |
| | | to show a drop location where the |
| | | next process can be added to the |
| | | workflow. |
| Vertical Arrow | No | Directional arrow between sequenced |
| (Pass Conditional | | processes placed in a branch off |
| Link) | | the main flow. A distinctly bold |
| | | arrow may be used to show a drop |
| | | location where the next process can |
| | | be added to the workflow. |
| Angled Fail | No | Angled directional arrow between |
| Process Arrow | | sequenced processes defining an |
| (Fail Conditional | | alternate path in case of a failed |
| Link) | | process. A distinctly bold arrow may |
| | | be used to show a drop location where |
| | | the fail process can be added to |
| | | the workflow. |
| Loop Back Graphic | No | An optional curved-down arrow to |
| (optional) | | represent a start of a loop back path. |
| | | An adjacent sequenced number may be |
| | | shown to indicate the associated |
| | | loop back. |
| Loop Back | No | An optional curved-up arrow to |
| Target | | represent a loop back path destination. |
| (optional) | | An adjacent sequenced number may be |
| | | shown to indicate the associated |
| | | loop back. |
| Process Failed | No | “X” marking to show a process |
| Indicator | | failure. Also shown associated with the |
| | | Angled Fail Process Arrow. |

Referring to Table 1, the Loop Back icon defines an optional feature to return a failed process to a selected process step in a selected workflow. Upon placement of the Loop Back icon in the workspace 150, a Loop Back dialog may be invoked by double clicking the Loop Back icon.

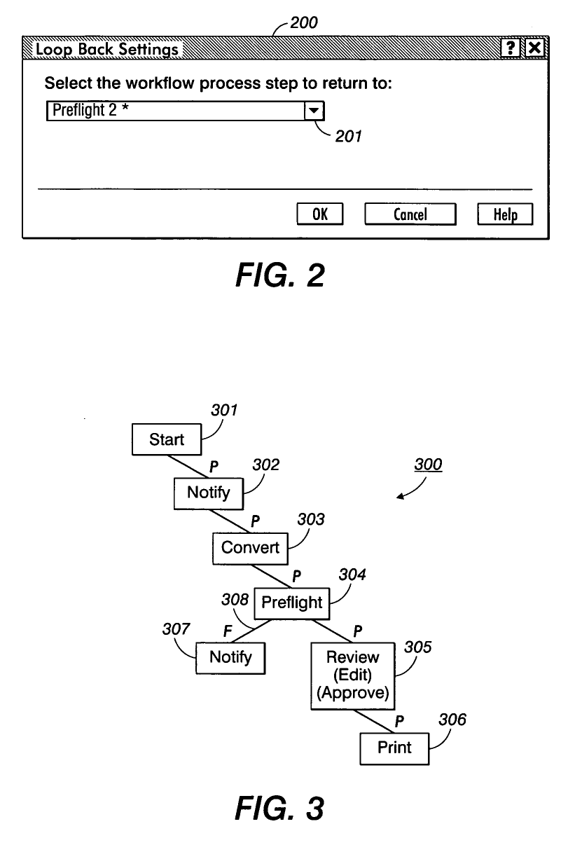

As shown in FIG. 2, a combo box 201 of a Loop Back dialog 200 allows a selection of the workflow process step from a list of the applicable process steps for the selected workflow. When the workflow gets to the Loop Back step, the Loop Back step will redirect the workflow to the process step specified in the combo box 201. The default return process step may be the process step that originated the branch.

Loop Back 142, shown in FIG. 1, may include a Review 133 process. Otherwise, a circular workflow may result with no Review process to correct the originating failure condition.

Certain placement rules may be imposed in constructing a workflow in the workspace 150. For example, the following placement rules may be used. If Convert exists in a workflow, it must precede the following process steps: Join, Preflight, Color Manage, Impose, Review, Job Level Edit, Production Print and Save. If Join exists in a workflow, it must precede the following steps: Preflight, Color Manage, Impose, Review, Job Level Edit and Production Print. These rules are exemplary for the instant production print process, and are meant to be illustrative. Other drag-and-drop placement rules specific to other business applications may be utilized for efficiency and simplicity in workflow construction.

Process objects may be dragged to, from and within the workspace 150 to construct workflows. Table 2 tabulates a non-exhaustive list of exemplary drag-and-drop attributes. If a listed attribute pertains to a process object, the “Process Object” entry is indicated by “Yes.” The listing is not intended to be a complete listing, but is intended to exemplify certain novel drag-and-drop features that may be employed.

TABLE 2

| | Process | |
|---|---|---|
| Action | Object? | Description of the Object Attribute |
| Mouse over | Yes | The object changes in appearance to |
| object | | show that the object can be dragged. |
| Dragging an | Yes | The object is ghosted (semi- |
| object | | transparent) when the object is |
| | | selected and dragged. |
| Locating a drop | Yes | Acceptable drop locations may be |
| location | | indicated with a variety of drop |
| | | target graphics, e.g., a distinctly |
| | | bold arrow. Also, an audible click |
| | | and/or cursor changes may be invoked |
| | | when dragging over an acceptable |
| | | drop location. |
| Dropping at | Yes | The default drop location in a |
| the end of | | workspace is the end of the workflow |
| the workflow | | being constructed. A link arrow is |
| | | automatically drawn upon dropping. |
| Drop sequencing | Yes | Valid workflow sequencing is imposed. |
| | | See the placement rules. |
| Dropping between | Yes | Workflow processes automatically |
| objects | | shift if another process is placed |
| | | between linked steps. Link arrows |
| | | are automatically reconfigured upon |
| | | dropping. |
| Dropping outside | Yes | If an object is dropped on the |
| of a drop location | | workspace but outside of a drop |
| | | location, the object preferably snaps |
| | | to a drop location. A link arrow is |
| | | automatically drawn |
| | | upon dropping. |
| Dropping near a | Yes | Objects preferably snap into place |
| drop location | | when they are dropped near or |
| | | overlapping acceptable drop locations. |
| | | A link arrow is automatically drawn |
| | | upon dropping. |
| Opening a | Yes | Opened by right mouse click over a |
| context menu | | process in the workspace. Context |
| | | menu may comprise, e.g., Cut, Copy, |
| | | Paste, Paste as Fail Branch, Delete, |
| | | Process Settings, Separator line, |
| | | Draw Link, and Show Link. |
| Draw Link | No | Optionally, once selected, context |
| (optional) | | menu closes and the pointer cursor |
| | | is replaced by the Loop Back Target |
| | | process icon. |
| Show Link | No | Optionally, once selected, context |
| (optional) | | menu closes and the Loop Back Target |
| | | icon for the process is distinctly |
| | | represented (blinks). |

The workflow builder may also feature contingent branching. Contingent branching, as graphically branched by an Angled Fail Process Arrow (Table 1), is branched from a process failure. The contingent branching may be collapsed from view. The default view may be a collapsed state. Further, one contingent branch may be opened per workflow, for example.

Table 3 tabulates a non-exhaustive list of exemplary contingent branching attributes. If the contingent branching action pertains to a process object, the “Process Associated” entry is indicated by “Yes”. The listing is not intended to be a complete listing, but is intended to exemplify certain novel contingent branching features.

TABLE 3

| | Process | |
|---|---|---|
| Action | Associated | Contingent Branching Attributes |
| Clicking a “+” icon | Yes | A contingent branch may be opened |
| | | in the workspace by mouse clicking |
| | | a “+” icon. |
| Clicking a “−” icon | Yes | A contingent branch may be collapsed |
| | | in the workspace by mouse clicking a |
| | | “−” icon. |
| Clicking a different | Yes | Preferably, one branch may be open |
| “+” icon | | at a time. Clicking a different |
| | | “+” icon closes the previously |
| | | opened branch and opens the clicked |
| | | branch. |

FIG. 3 schematically illustrates an exemplary workflow 300 using the process steps listed in Table 1, the drag-and-drop features listed in Table 2 and other described workflow construction rules and features. As shown in FIG. 3, the primary tasks for the exemplary simple workflow are linked by Pass “P” conditional links in the following order: Start 301, Notify 302, Convert 303, Preflight 304, Review 305, and Print 306. Contingent branching is shown as a Fail “F” conditional link 308, linking Preflight 304 and Notify 307.

FIG. 4 separately shows a Workflow Process Options area 130 and a workspace 150 view of such an exemplary workflow. As shown in FIG. 4, the primary tasks progress in the same order: Start 301, Notify1 302, Convert1 303, Preflight1 304, Review 305, and Print1 306. Such an exemplary workflow may model a start of job 301 with a user file input; the user being notified 302 by email of the job start confirmation/status; converting 303 the submitted user file into PDF format; performing a “preflight” check 304 of the PDF job for completeness, such as availability of the required drives, fonts, etc.; notifying user/operator 305 requesting user/operator review/approval of the PFD job before proceeding to production printing; and production printing 306 of a PDF file. The contingent branching is shown as an Angled Fail Process Arrow 308 with an adjacent Process Failed Indicator in FIG. 4, the contingent fail step being Notify2 307, to distinguish from the earlier Notify1 302. In accordance with a placement rule, Convert1 303 precedes Preflight1 304, Review 305 and Print1 306. In the contingent branching 308, the operator/user is notified 307 in case of a process failure, but no Review step is shown because the Loop Back step is not implemented.

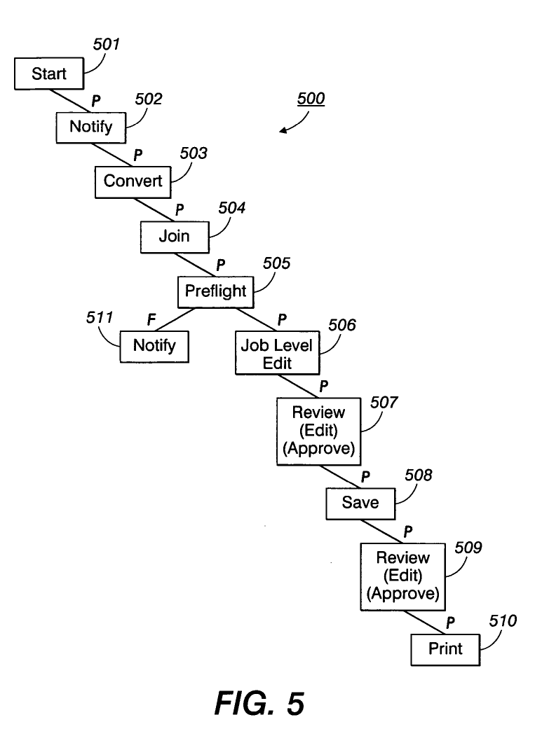

FIG. 5 schematically illustrates another exemplary workflow 500. As shown in FIG. 5, the primary tasks for the exemplary workflow are linked by Pass “P” conditional links in the following order: Start 501, Notify 502, Convert 503, Join 504, Preflight 505, Job Level Edit 506, Review 507, Save 508, Review 509, and Print 510. Contingent branching is shown as a Fail “F” conditional link, linking Preflight 505 and Notify 511. In accordance with a placement rule, Convert 503 precedes Join 504. Such another exemplary-workflow may model a start of job 501 with user file inputs; the user being notified 502 by email of the job start confirmation/status; converting 503 the submitted user files into PDF format; joining 504 one or more user files into one file; performing a “preflight” check 505 of the PDF job for completeness, such as availability of the required drives, fonts, etc.; automatically editing the PDF job 506 for margins, page numbering, watermarks, etc.; notifying user/operator 507 requesting user/operator review/approval of the edited PDF job; saving 508 the PDF job; notifying user/operator 509 requesting user/operator review/approval of the PDF job before proceeding to production printing; and production printing 510 of a PFD file. As before, in the contingent branching, the operator/user is notified 511 in case of a process failure.

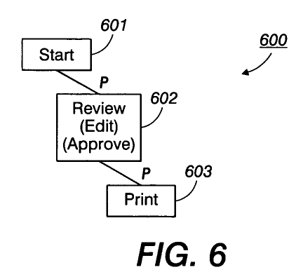

FIG. 6 schematically illustrates an exemplary reprint workflow 600. As shown in FIG. 6, the primary tasks, Start 601, Review 602, and Print 603, are linked by Pass “P” conditional links. No contingent branching is shown.

While this invention has been described in conjunction with various exemplary implementations, it should be appreciated that the principles of this invention can be equally applied to any known or later developed applications amenable to workflow construction. Accordingly, the details set forth above are intended to be illustrative, and not limiting. For example, the disclosed systems, methods and user interfaces for document workflow construction are equally applicable to print or copy production; accounting; and publication, news or advertising prepress workflows.

What is claimed is:

1. A user interface for document workflow construction, comprising:
a toolbar palette from which a toolbar task is selectable for replication as an icon; and
a workflow pane to which the icon may be dragged and dropped at an indicated drop location.

2. The user interface of claim 1, wherein dropping a second icon in the workflow pane establishes a link to the previously dropped icon.

3. The user interface of claim 2, wherein a fail branch may be established offset from a selected icon of the row of linked icons by dropping a third icon.

4. The user interface of claim 3, wherein another set of linked icons may be constructed as an error-handling branch, branched and offset from the linked icons, by dropping a fourth icon at an indicated drop location near the third icon.

5. The user interface of claim 4, wherein the error-handling branch is collapsible.

6. The user interface of claim 1, wherein the toolbar palette includes selectable toolbar tasks comprising at least one of Join, Convert, Review, Color Management, Impose, Job Level Edit, Notify, Preflight, Production Print, Save Job, and JDF Export, a selectable toolbar task representing a production print process.

7. The user interface of claim 6, wherein the user interface follows a rule that Convert precedes Join, Preflight, Color Manage, Impose, Review, Job Level Edit and Print, and a rule that Join precedes Preflight, Color Manage, Impose, Review, Job Level Edit and Print.

8. The user interface of claim 4, wherein the toolbar palette includes selectable toolbar tasks comprising at least one of Join, Convert, Review, Color Management, Impose, Job Level Edit, Notify, Preflight, Production Print, Save Job, JDF Export, and Loop Back, a selectable toolbar task representing a production print process.

9. A system using the user interface of claim 1, wherein the user interface is used to construct workflows for at least one application chosen from the group comprising print production, copy production, and accounting.

10. A method for constructing a document workflow using a user interface which includes a toolbar palette from which a toolbar task is selectable for replication as an icon and a workflow pane to which the icon may be dragged and dropped, the method comprising:
disposing a dropped icon at an indicated drop location; and
establishing a link from another disposed icon to the disposed dropped icon.

11. The method of claim 10, wherein selecting a second toolbar task for replication as another icon and dropping a second icon in the workflow pane establishes a link to the previously dropped icon to form a row of linked icons.

12. The method of claim 11, wherein an icon of the row of linked icons may be selected to establish a fail branch.

13. The method of claim 12, wherein selecting a third toolbar task and dropping a third icon at an indicated drop location for the fail branch constructs another row of linked icons as an error-handling branch, branched and offset from the row of linked icons.

14. The method of claim 13, wherein the error-handling branch may be collapsed and opened.

15. The method of claim 10, wherein the toolbar palette includes selectable toolbar tasks comprising at least one of Join, Convert, Review, Color Management, Impose, Job Level Edit, Notify, Preflight, Production Print, Save Job, and JDF Export, a selectable toolbar task representing a production print process.

16. The method of claim 15, wherein the method follows a rule that Convert precedes Join, Preflight, Color Manage, Impose, Review, Job Level Edit and Print, and a rule that Join precedes Preflight, Color Manage, Impose, Review, Job Level Edit and Print.

17. The method of claim 13, wherein the toolbar palette includes selectable toolbar tasks comprising at least one of Join, Convert, Review, Color Management, Impose, Job Level Edit, Notify, Preflight, Production Print, Save Job, JDF Export, and Loop Back, a selectable toolbar task representing a production print process.

18. A system using the method of claim 10, wherein the method is used to construct workflows for at least one application chosen from the group comprising print production, copy production, and accounting.

19. A computer program embodied on computer-readable medium to perform the method of claim 10, wherein the computer program implements a user interface for constructing workflows.

20. The computer program according to claim 19, wherein the computer program implements a user interface for constructing workflows for at least one application chosen from the group comprising print production, copy production, and accounting.
